(19) United States
(12) Patent Application Publication
(10) Pub. No.: US 2024/0250373 A1
(43) Pub. Date: Jul. 25, 2024

(54) COMPRESSION CASE FOR BATTERIES

(71) Applicant: Rivian IP Holdings, LLC, Plymouth, MI (US)

(72) Inventor: Bharat Kathpalia, San Francisco, CA (US)

(21) Appl. No.: 18/100,507

(22) Filed: Jan. 23, 2023

(51) Int. Cl. H01M 50/289; B60L 50/64; H01M 10/655; H01M 50/211; H01M 50/505

(52) U.S. Cl. CPC H01M 50/289; B60L 50/64; H01M 10/655; H01M 50/211; H01M 50/505

(57) ABSTRACT

Aspects of the disclosure relate to the use of an expanding foam to provide a stack pressure for battery cells such as solid-state pouch cells. In one or more implementations, a battery, a battery unit, a battery module or a battery pack is provided with one or more battery cells within an internal volume of a casing. An initial volume of an expanding foam is introduced into the internal volume, and allowed to expand to substantially fill a remaining portion of the internal volume and to provide the stack pressure on the battery cells.

### INTRODUCTION

Batteries are often used as a source of power, including as a source of power for electric vehicles that include wheels that are driven by an electric motor that receives power from the battery.

Aspects of the subject technology may reduce the weight and/or extend the efficiency and/or range of an electric vehicle, which may help to mitigate climate change by reducing greenhouse gas emissions.

### SUMMARY

The present description relates generally to a battery casing that provides a desired stack pressure for cells in the battery casing, particularly (in some examples) for pouch cells. In one or more implementations, an expanding foam may be injected into an internal volume of a casing of a battery or battery unit in which one or more cells (e.g., pouch cells, such as a solid-state pouch cells) are disposed. The expanding foam may have a maximum expanded volume that is larger than the remaining volume within the casing, and the expanding foam may therefore expand to substantially fill the remaining volume within the casing, and to pressurize the remaining volume to provide the desired stack pressure. The stack pressure provided by the foam may be as much as, or more than, 1 MPa-5 MPa in various implementations.

In accordance with one or more aspects of the disclosure, a battery is provided. The casing may be configured to enclose one or more battery cells within a portion of the internal volume of the casing. The battery may also include a foam that substantially fills a remaining portion of the internal volume of the casing and is configured to apply a pressure on the one or more battery cells.

The battery may include the one or more battery cells disposed within the portion of the internal volume of the casing, and the one or more battery cells may include solid state pouch cells each having a flexible pouch housing that is in contact with and receives the pressure from the foam. The foam may have a density greater than 0.4 grams per cubic centimeter. The foam may be a closed cell foam that applies the pressure on the one or more battery cells and that is compliant to allow an expansion of one or more of the one or more battery cells while substantially maintaining the pressure on the one or more of the one or more battery cells. In one or more implementations, the pressure on the one or more battery cells may be greater than one MPa. In one or more implementations, the pressure on the one or more battery cells may be greater than five MPa.

In one or more implementations, the battery may also include an interconnect busway on an outer surface of the casing. Each of the one or more battery cells may include a tab that extends through the casing and contacts a corresponding portion of the interconnect busway. The one or more battery cells may include one or more pairs of battery cells mounted within the internal volume of the casing. Each of the one or more pairs of battery cells may include a first battery cell mounted in a first polarity orientation, and a second battery cell mounted in a second polarity orientation opposite the first polarity orientation. The battery may also include a temperature control element disposed between the first battery cell and the second battery cell of each of the one or more pairs of battery cells.

The interconnect busway on the outer surface of the casing may include a positive parallel interconnect busway on the outer surface of the casing and coupled to the first battery cell of each of the one or more pairs of battery cells, and the battery may also include a negative parallel interconnect busway on the outer surface of the casing and coupled to the second battery cell of each of the one or more pairs of battery cells. The first battery cell of each of the one or more pairs of battery cells may include a tab that is coupled to a tab of the second battery cell of that pair of battery cells at a location adjacent another outer surface of the casing that is opposite to the outer surface of the casing.

In accordance with one or more aspects of the disclosure, a battery pack is provided. The battery pack may include a casing that defines an internal volume. The casing may be configured to enclose one or more battery cells within a portion of the internal volume of the casing. The battery may also include a foam that substantially fills a remaining portion of the internal volume of the casing and is configured to apply a pressure on the one or more battery cells. The battery pack may also include a pack frame; a first battery unit in the pack frame, the first battery unit including the casing, the one or more battery cells, and the foam, the first battery unit having a first polarity orientation; and a second battery unit in the pack frame and having a second polarity orientation substantially opposite the first polarity orientation. In one or more implementations, the foam may include a closed cell foam and the pressure on the one or more battery cells may include a pressure of greater than one MPa.

In one or more implementations, the battery pack may also include a pack frame; a first battery unit having the casing, the one or more battery cells, and the foam, and in which the foam applies a first pressure on the one or more battery cells of the first battery unit; and a second battery unit in which a second foam applies a second pressure, different from the first pressure, on one or more battery cells of the second battery unit.

In one or more implementations, the battery pack may also include a pack frame with a longitudinal support structure separating a first row of battery units from a second row of battery units within the pack frame. The first row of battery units may include a first battery unit including the casing, the one or more battery cells, and the foam. In one or more implementations, the pack frame or the battery unit may be implemented in a vehicle.

In accordance with one or more aspects of the disclosure, a method is provided that includes obtaining a battery casing that defines an internal volume and having a plurality of battery cells disposed in the internal volume; injecting a foam into a remaining portion of the internal volume to partially fill the remaining portion of the internal volume; allowing the foam to expand to substantially fill the remaining portion of the internal volume and to apply a predetermined pressure to the plurality of battery cells; and providing a battery comprising the casing, the plurality of battery cells, and the expanded foam, for storage of electrical energy. The predetermined pressure on the plurality of battery cells may be greater than one MPa. The method may also include installing the battery in a vehicle.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates a schematic perspective view of battery modules that may be included in a battery pack in accordance with one or more implementations.

FIG. 2C illustrates a partially exploded cross-sectional perspective view of a pouch battery cell in accordance with one or more implementations.

FIG. 3 illustrates a cross-sectional side view of an example battery in accordance with one or more implementations.

FIG. 4 illustrates a cross-sectional end view of an example battery in accordance with one or more implementations.

FIG. 5 illustrates a cross-sectional end view of another example battery in accordance with one or more implementations.

FIG. 6 illustrates a cross-sectional end view of an example battery having cooling structures in accordance with one or more implementations.

FIG. 7 illustrates a top view of an example battery in accordance with one or more implementations.

FIG. 8 illustrates a top view of another example battery in accordance with one or more implementations.

FIG. 9 illustrates a bottom view of the example battery of FIG. 8 in accordance with one or more implementations.

FIG. 10 illustrates a cross-sectional side view of the example battery of FIG. 6 in accordance with one or more implementations.

FIGS. 11A and 11B illustrate top and bottom views of an example battery pack having batteries as described herein in a blade-style arrangement in accordance with one or more implementations.

FIG. 12 illustrates a top view of an example battery pack having multiple rows of battery units as described herein in a blade-style arrangement in accordance with one or more implementations.

FIG. 13 illustrates a top view of another example battery pack having batteries as described herein in a blade-style arrangement in accordance with one or more implementations.

FIG. 14 illustrates a top view of another example battery pack having multiple rows of battery units as described herein in a blade-style arrangement in accordance with one or more implementations.

FIG. 15 illustrates a flow chart of example operations that may be performed for manufacturing a battery, a battery unit, a battery module or a battery pack in accordance with implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology relate to batteries, battery units, battery modules or battery packs having a casing within which battery cells are disposed, and within which a foam fills a remaining internal volume within the casing and pressurizes the internal volume of the casing. By tuning the expansion of the foam and the cell size of the foam, an expanding foam may be provided for battery casings that is formulated and arranged to both compress a battery cell (e.g., a solid-state battery (SSB) cell, such as a solid-state pouch cell) within the casing at sufficient pressure, and allow for compliance to volume growth of the battery cell once the expanding foam is set.

For example, expanding foams, such as expanding foam epoxies, can have an expansion ratio of up to 1:10 in an open cup (e.g., unconstrained) setting. In an expanding foam epoxy, this expansion is a function of a curing process between the two parts of the epoxy. When an initial amount or volume (V) of an expanding foam epoxy is placed inside a container with volume smaller than the full expanded volume (e.g., 10×V), the constrained expansion of the foam results in an increase in internal pressure within the container.

In one or more implementations, one or more pouch cells may be encased in a casing, and an expanding foam (e.g., an expanding foam epoxy) may be injected into the casing. The initial amount or volume of the foam that is injected into the casing may be sized to cause the (e.g., unconstrained) final expanded volume of the expanded foam to be larger than the free volume left in the casing. When the foam is prevented from expanding to its unconstrained final volume by the casing, the expansion of the foam results in an increase of pressure inside the casing, providing a desired stack pressure for the SSB pouch cells. The initial amount or volume of the foam that is provided into the casing can be selectable to provide the manufacturing flexibility and advantage to result in any desirable pressure on the cell(s) in the casing. The closed cell nature of the expanded foam can also be arranged to provide compliance to volume expansion of the battery cells, as desired.

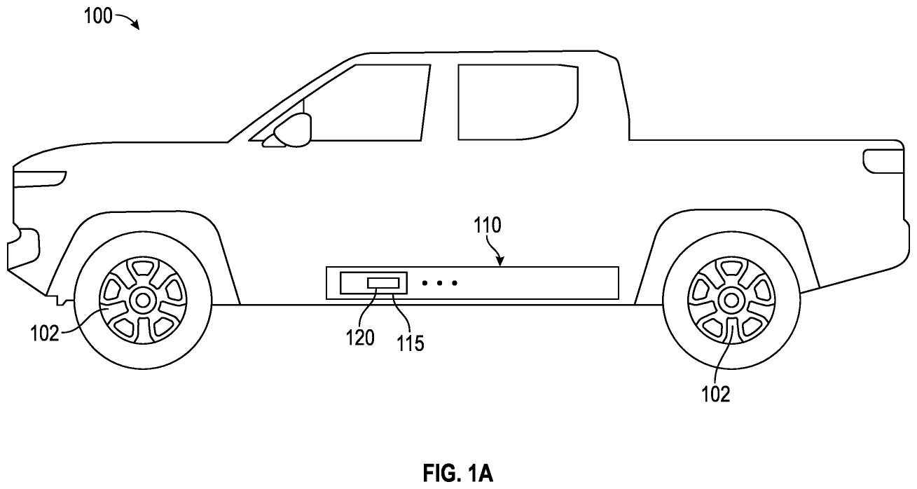

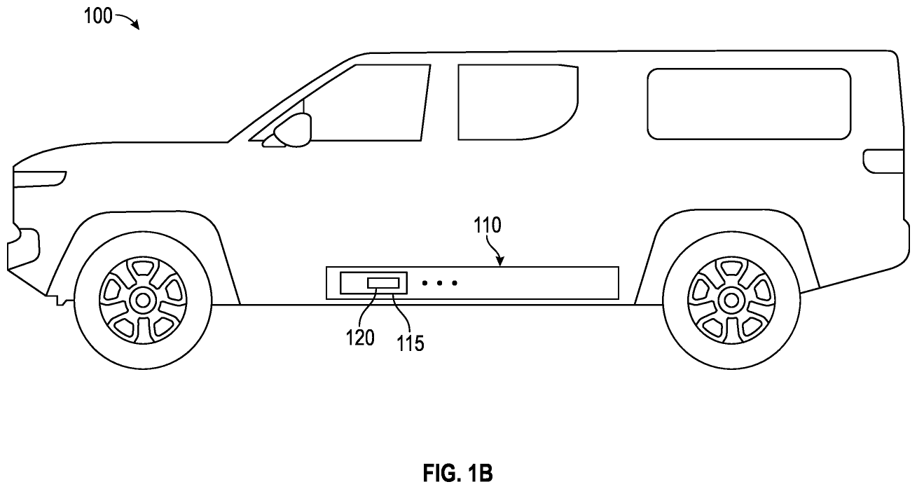

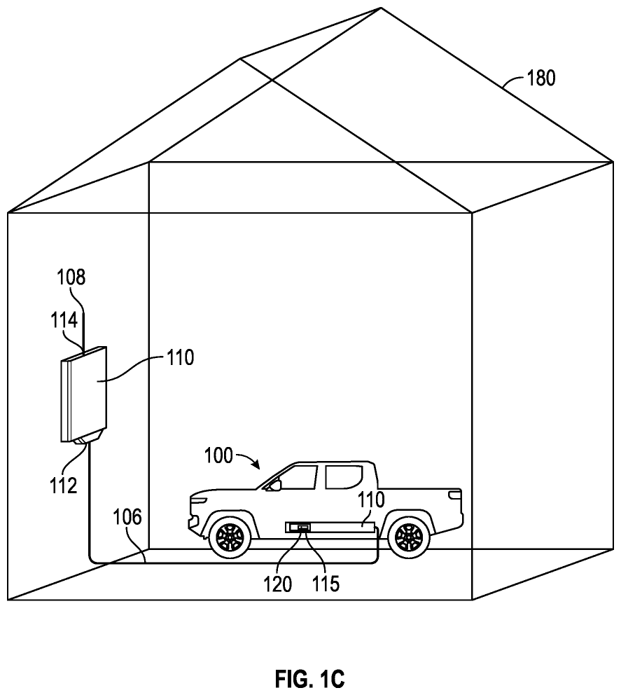

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, the vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1A, the vehicle 100 is implemented as a truck (e.g., a pickup truck) having a battery pack 110. As shown, the battery pack 110 may include one or more battery modules 115, which may include one or more battery cells 120. However, this is merely illustrative and, in other implementations, the battery pack 110 may be provided without any battery modules 115 and with the battery cells mounted directly in the battery pack 110 (e.g., in a cell-to-pack configuration) and/or in other battery units that are installed in the battery pack 110. A vehicle battery pack can include multiple energy storage devices that can be arranged into battery modules or battery units. A battery unit or module can include an assembly of cells that can be combined with other elements (e.g., structural frame, thermal management devices) that can protect the assembly of cells from heat, shock and/or vibrations.

For example, the battery cell 120 can be included in a battery, a battery unit, a battery module and/or a battery pack to power components of the electric vehicle 100. For example, a battery cell housing of the battery cell 120 can be disposed in the battery module 115, the battery pack 120, a battery array, or other battery unit (e.g., a unit including a casing and a pressurizing foam as described in further detail hereinafter) installed in the electric vehicle 100. As discussed in further detail hereinafter, the battery cell housing can be of any shape. The battery cell housing can include a pouch that forms a flexible or malleable housing for the battery cell. The battery cell housing can include other form factors, such as a triangle, a square, a rectangle, a pentagon, and a hexagon, among others. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115, and/or in which one or more the battery cells 120 are provided in a battery casing, with a pressurizing foam, to form a battery unit. In one or more implementations, the vehicle 100 may include one or more busbars, electrical connectors, or other charge collecting and/or coupling components to provide electrical power from the battery pack 110 to various systems or components of the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area in at least a rear portion of the vehicle that is enclosed within the vehicle 100 (e.g., behind a row of seats within a cabin of the vehicle). In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having a battery pack 110 (e.g., that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building or structure having an electrical system. As shown, in one or more implementations, a battery pack 110 may be mounted to a wall of the building 180.

As shown, the battery pack 110 that is installed in the building 180 may be couplable to the battery pack 110 in the vehicle 100, such as by a cable/connector 106. For example, the cable/connector 106 may be coupled to an external connector 112 (e.g., a high voltage terminal) on the battery pack 110. In this way, the battery pack 110 that is installed in the building 180 may be used to charge the battery pack 110 in the vehicle 100 in some use cases. In some examples, the battery pack 110 that is installed in the building 180 may also, or alternatively, be coupled (e.g., via a cable/connector 108 or other electrical connection) to an electrical power system, such as solar power source, a wind power source, and/or an electrical grid of a city, town, or other geographic region. For example, the cable/connector 108 may be coupled to another external connector 114 (e.g., a high voltage terminal) on the battery pack 110. During, for example, times when the battery pack 110 in the vehicle 100 is disconnected from the battery pack 110 that is installed in the building 180, the battery pack 110 that is installed in the building 180 can charge up and store electrical energy. This stored electrical energy in the battery pack 110 that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the cable/connector 108 and/or another electrical connection may electrically couple the battery pack 110 that is installed in the building 180 to an electrical system of the building 180. For example, the battery pack 110 that is installed in the building 180 may be used to power one or more lights, lamps, appliances, fans, heaters, air conditioners, and/or any other electrical components or devices in the building 180 (e.g., via one or more electrical outlets that are coupled to the battery pack 110 that is installed in the building 180). In one or more use cases, the battery pack 110 that is installed in the building 180 may be used as a source of electrical power for the building 180 during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery pack 110 that is installed in the building 180 and/or to power the electrical system of the building 180 (e.g., in a use case in which the battery pack 110 that is installed in the building 180 is low on or out of stored energy and in which solar power or wind power is not available, a regional or local power outage occurs for the building 180, and/or a period of high rates for access to the electrical grid occurs (as examples)).

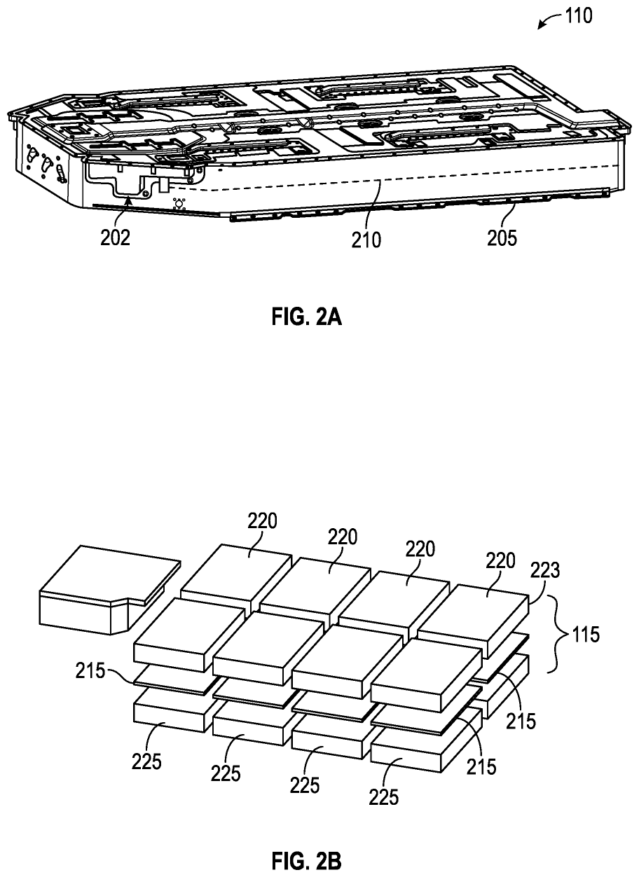

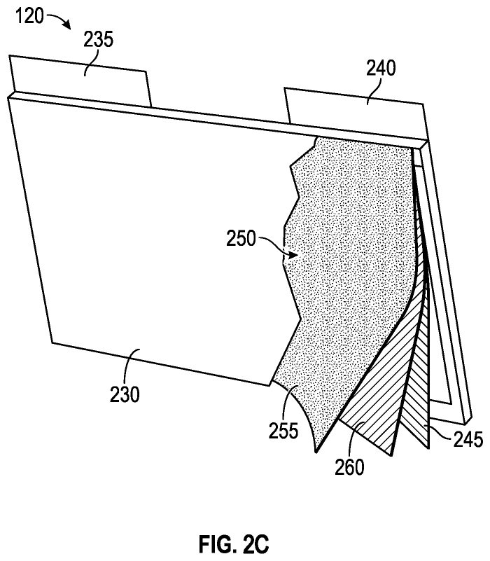

FIG. 2A depicts an example battery pack 110. Battery pack 110 may include multiple battery cells 120 (e.g., directly installed within the battery pack 110, or within batteries, battery units, and/or battery modules 115 as described herein), and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries and/or battery modules 115 within the battery pack frame 205 to generate a desired output voltage for the battery pack 110. The battery pack 110 may also include one or more external connection ports, such as an electrical contact 202 (e.g., a high voltage terminal). For example, an electrical cable (e.g., cable/connector 106) may be connected between the electrical contact 202 and an electrical system of the vehicle 100 or the building 180, to provide electrical power to the vehicle 100 or the building 180.

As shown, the battery pack 110 may include battery pack frame 205 (e.g., a battery pack housing or pack frame). For example, the battery pack frame 205 may house or enclose one or more battery modules 115, one or more battery cells 120 housed in a casing with a pressurizing foam, and/or other battery pack components. In one or more implementations, the battery pack frame 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

In one or more implementations, the battery pack 110 may include one or more thermal control structures 210 (e.g., cooling lines and/or plates and/or heating lines and/or plates). For example, thermal control structures 210 may couple thermal control structures and/or fluids to the battery modules 115, battery units, batteries, and/or battery cells 120 within the battery pack frame 205, such as by distributing fluid through the battery pack 110. For example, the thermal control structures 210 may form a part of a thermal/temperature control or heat exchange system that includes one or more thermal components 215 (e.g., plates or bladders) as shown in FIG. 2B. For example, a thermal component 215 may be positioned in contact with one or more battery modules 115, battery units, batteries, and/or battery cells 120 within the battery pack frame 205. In one or more implementations, the battery pack 110 may include one or multiple thermal control structures 210 and/or thermal components 215 for each of several top and bottom battery module pairs. The thermal control structure 210 can be coupled with, part of, or independent from the thermal component 215.

FIG. 2B depicts an example of battery modules 115 that may be disposed in the battery pack 110 (e.g., within the battery pack frame 205 of FIG. 2A). In the example of FIG. 2B, the battery modules 115 include two rows of top modules 220 aligned with two rows of bottom modules 225. In this example, each row of the battery modules 115 includes four battery modules, and the battery modules 115 each have a width that is substantially similar to its length. In one or more other implementations, the battery modules 115 of the battery pack 110 may include more or fewer than two rows of battery modules 115, more or fewer than four battery modules 115 in each row, and/or battery modules having other shapes and/or arrangements. For example, in one or more implementations, the battery modules 115 may have an elongate shape in which the length of the battery module (e.g., along a direction from a front end of the battery pack 110 to a rear end of the battery pack 110) is substantially greater than a width (e.g., in a transverse direction to the direction from the front end of the battery pack 110 to the rear end of the battery pack 110) of the battery module. For example, one or more battery modules 115 may span the entire front-to-back length of a battery pack within the battery pack frame 205. In one or more other implementations, a battery pack 110 may be provided without battery modules 115 (e.g., in a cell-to-pack implementation).

As shown in the example of FIG. 2B, a thermal component 215 may be disposed between a corresponding top module 220 and a corresponding bottom module 225 of the battery modules 115 in one or more implementations. For example, one thermal component 215 can be configured for heat exchange with one battery module 115, or with one top module 220 and one bottom module 225. In one or more implementations, the battery modules 115 may be coupled (e.g., in series) to a current collector of the battery pack 110, the current collector being coupled, via a high voltage harness, to one or more external connectors (e.g., electrical contact 202) on the battery pack 110.

In one or more implementations, each of the battery modules 115 may include one or more battery cells 120. In one or more implementations, the battery modules 115 can be disposed within the battery pack frame 205 of the battery pack 110. The battery modules 115 may include battery cells 120 that are implemented as pouch cells in one or more implementations. In one or more implementations, a battery module 115 may operate as a modular unit of multiple battery cells 120. For example, the battery modules 115 may collect current or electrical power from multiple battery cells 120 that are included in the battery module 115 and can provide the current or electrical power as output from the battery pack 110. The battery pack 110 may include any number of battery modules 115. For example, the battery pack 110 may include one, two, three, four, five, six, seven, eight, nine, ten, eleven, twelve or any other number of battery modules 115 disposed in the battery pack frame 205.

As shown in FIG. 2B, each of the battery modules 115 may including a module casing 223 within which one or more (e.g., multiple) battery cells 120, batteries, and/or battery units (e.g., having their own casings within which a pressurizing foam is disposed) may be disposed. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate module casing 223). For example, the battery pack 110 (e.g., the battery pack frame 205) may include or define a one or more structures for positioning of the battery cells 120 directly within the battery pack frame 205. In various implementations, any or all of the battery modules 115 may have a shape that is square, rectangular, circular, triangular, symmetrical, or asymmetrical. In some examples, battery modules 115 may implemented with varying shapes, such that some battery modules 115 are rectangular and other battery modules 115 are square, cylindrical or other housed in other shaped housings. One or more of the battery modules 115 may include or define one or more slots, holders, or containers for one or more battery cells 120 in one or more implementations.

Battery cells 120 may be provided in a variety of form factors, shapes, or sizes. For example, battery cells 120 may have a rectangular, square, cubic, flat, elongated, or other form factor. In various examples, battery cells 120 can be assembled, for example, by inserting an assembly including anode, cathode, electrolyte material, and/or separator (if present) into at least one battery cell housing (e.g., cell housing 230). The electrolyte material (e.g., an ionically conductive fluid or other liquid or solid electrolyte material) may facilitate the conduction of ions between a positive electrode and a negative electrode during charge and/or discharge processes. In one or more implementations, the battery cell 120 may include a liquid electrolyte material. In one or more other implementations, the battery cell 120 can include a solid electrolyte material.

As shown in FIG. 2C, the battery cell 120 may include one or more terminals such as a first terminal 235 having a first polarity and a second terminal 240 having a second polarity. For example, the first terminal 235 may be a positive polarity terminal that is coupled (e.g., via first current collector such as a copper current collector) to a cathode layer 255 of the battery cell 120. For example, the second terminal 240 may be a negative polarity terminal that is coupled (e.g., via a second current collector such as an aluminum current collector) to an anode layer 245 of the battery cell 120. As shown in FIG. 2C, the battery cell 120 may also include a layer 260 between the anode layer 245 and the cathode layer 255.

In one or more implementations, the layer 260 may be a solid state electrolyte layer that separates the anode layer 245 from the cathode layer 255. The solid state electrolyte layer facilitates transfer of ions between the anode layer 245 and the cathode layer 255 during charging and/or discharging of the battery cell 120.

In one or more other implementations, the layer 260 may include a solid electrolyte layer. In this configuration, the layer 260 may be free of an additional separator layer, and the solid electrolyte layer itself separate the anode layer 245 and the cathode layer 255. As examples, a solid electrolyte layer may be or include an inorganic solid electrolyte, a solid polymer electrolyte, or a quasi-solid electrolyte in which a liquid electrolyte is suspended in a solid matrix material. In various examples, a solid-state battery cell may include a solid electrolyte (e.g., and may be free of liquid electrolytes) may include a silicon-based anode, a lithium metal anode, or a lithium free metal anode (in some examples).

As shown in FIG. 2C, the battery cell 120 may be implemented as a pouch cell. In the example of FIG. 2C, the anode layer 245, the layer 260 (e.g., a separator layer with a liquid electrolyte, or a solid electrolyte layer), and the cathode layer 255 may be stacked and sealed within a cell housing 230 that is implemented as a flexible housing. For example, the cell housing 230 of FIG. 2C may be formed from a flexible or malleable material such as foil or a film (e.g., an aluminum coated plastic film). In this way, the size, thickness, and/or weight of the cell housing 230 can be significantly reduced relative to the size, thickness, and/or weight of other battery cell form factors, such as cylindrical cells and/or prismatic cells.

In implementations in which the battery cells 120 are implemented as pouch cells (e.g., as in the example of FIG. 2C), the pouch cells may be solid-state pouch cells. Pouch cells and/or prismatic cells that include liquid electrolytes and/or other liquid layers and/or materials may be provided with some amount of stack pressure (e.g., less than or equal to IMPa) to counteract volume growth that can occur during cycling (e.g., charging and discharging) of the battery cell. Solid-state pouch cells (also referred to herein as Solid State Batteries (SSBs)) may experience a larger volume change than, for example, Lithium-Ion Batteries having liquid electrolytes (e.g., a solid state battery may experience a volume change that is 15-25% larger than the volume change of Lithium-Ion battery cells). In order to, for example, provide sufficient interfacial contact during the life of a SSB (e.g., a solid-state pouch cell), it may be beneficial to be able to provide a stack pressure that is significantly higher than the stack pressure that is used for liquid electrolyte battery cells. For example, a stack pressure of greater than 1 MPa, or as much as or more than 5 MPa may be provided for solid-state battery cells (SSBs). However, particularly, for example, in a pouch cell implementations, the stack pressure may not be provided by the battery cell housing 230 (e.g., the pouch) of the battery cell itself.

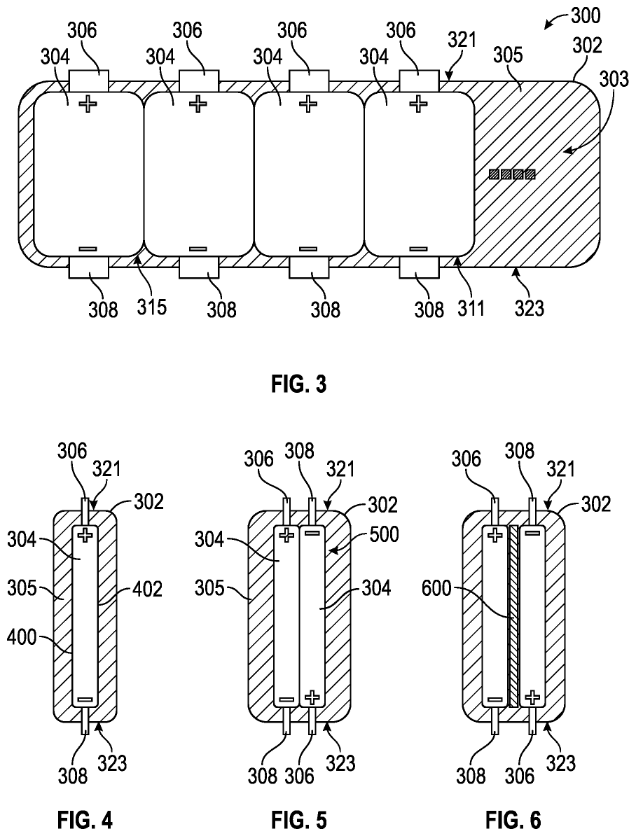

FIG. 3 illustrates an example of a battery (also referred to herein as a battery unit) that may provide a desired stack pressure for one or more battery cells within a casing. The example architecture of the battery of FIG. 3 may provide a sufficient stack pressure for solid-state pouch cells, while still allowing for compliance for battery volume change. As shown in FIG. 3, a battery 300 may include a casing 302 that defines an internal volume 303. Casing 302 may be a housing or other encasement that is formed from, as examples, one or more metals (e.g., a drawn aluminum), one or more plastic materials, and/or one or more fiber reinforced polymers (e.g., a nylon, such a glass-filled nylon material).

In one or more implementations, the battery 300 of FIG. 3 may be an implementation of the battery module 115 of FIGS. 1A-1C and 2B, in which the casing 302 is an implementation of the module casing 223. In one or more other implementations, the battery 300 may form a battery unit that can be installed directly in a battery pack 110 (e.g., as described hereinafter in connection with the examples of FIGS. 11A-14) without being a part of a battery module 115. In one or more other implementations, multiple batteries 300 (e.g., multiple battery units enclosed by multiple casings 302) may be combined (e.g., and electrically coupled together) to form a battery module 115.

One or more battery cells 304 (e.g., each of which may be an implementation of the pouch cell of FIG. 2C in a solid-state configuration, referred to herein as a solid-state pouch cell) may be disposed within the casing 302. As shown, the battery cells 304 may occupy a portion of the internal volume 303 of the casing 302.

As shown in FIG. 3, the battery 300 may include a foam 305 that substantially fills a remaining portion of the internal volume 303 (e.g., a remaining portion that is not filled or occupied by the battery cells 304 and/or other mechanical and/or electrical components within the internal volume 303) of the casing 302. The foam 305 may apply a pressure (e.g., a stack pressure) on the one or more battery cells (e.g., on the surfaces 311 of the battery cell housing 230 of the battery cells, such as substantially all of the surfaces 311 of the battery cell housing 230 of the battery cells 304 that are not in contact with another battery cell 304 or any other structures of the battery 300). For example, the battery cell housing 230 may include a flexible pouch housing that is in contact with and receives the pressure from the foam 305. As shown, the foam 305 may also contact and apply the same pressure that is applied to the battery cells 120 to an internal surface 317 of the casing 302. For example, the internal volume 303 may be substantially free of empty spaces that are not filled by the battery cells 304, associated structures and/or components, and foam 305. For example, as shown in FIG. 3, the foam 305 may substantially fill spaces 315 between curved portions of the battery cells 304.

In the example of FIG. 3, the battery cells 304 may be solid-state pouch cells (e.g., pouch cells as described in connection with FIG. 2C, and including solid electrolyte). In one or more implementations, the foam 305 may be formed from an expanding foam such as, for example, an expanding foam epoxy. Expanding foam epoxies may be thermosetting polymers in one or more implementations. Expanding foam epoxies may be formed from, for example, a mixing of two parts, such as a resin and a hardener. In one or more implementations, an expanding foam epoxy may be formed by mixing a polyol with a diisocyanate in a desired mixing ratio. Expanding foam epoxies can have an expansion ratio of up to 1:10 in an open cup setting (e.g., if unconstrained during expansion). This expansion is a function of a curing process between the parts of the epoxy.

In one or more implementations, an initial volume (V) of expanding foam epoxy may be placed inside a container (e.g., the casing 302) with an internal volume (e.g., internal volume 303) that is smaller than the full (e.g., unconstrained) expanded volume (e.g., 10×V) of the expanding foam epoxy, resulting in an increase in internal pressure within the container as the foam attempts to expand to its full (e.g., unconstrained) expanded volume. Using this property of expanding foam epoxies, the initial volume, V, of the foam 305 may be determined and injected into the internal volume 303 of the casing 302 in which the battery cells 304 are disposed, prior to expansion of the foam 305. The foam 305 may then be allowed to expand to substantially fill the remaining portion of the internal volume 303 and pressurize the internal volume 303 at a desired stack pressure for the battery cells 304. The pressure generated by the expanding foam may be controlled by the initial volume, V, (or amount) of the foam that is injected into the casing 302, the temperature of the injected foam, the ambient temperature of the room or location at which the foam is being injected, and/or the mixing ratio of the resin and the hardener. In one or more implementations, a cell size of the foam 305 can be tuned (e.g., by tuning the mixing ratio and/or the injection temperature) to allow for compliance of the expanded foam to volume growth of the battery cells 304 after the foam 305 is cured. In this way, the initial volume and the cell size of the foam 305 can be predetermined to both compress the battery cells 304 at a desired stack pressure, and to allow for compliance to volume growth of the battery cells 304 once the foam is set.

In one or more implementations, after expansion into the state shown in FIG. 3, the foam 305 may have a density greater than 0.1 grams per cubic centimeter (g/cc), greater than 0.2 g/cc, greater than 0.4 g/cc, greater than 0.5 g/cc, or greater than 1 g/cc. In one or more implementations, the foam 305 may be a closed cell foam that applies the pressure on the one or more battery cells 304 and that is compliant to allow an expansion of one or more of the one or more battery cells 304 while substantially maintaining the pressure on the one or more of the one or more battery cells 304. In one or more implementations, the pressure that is provided on the one or more battery cells 304 by the foam 305 may be greater than 1 megapascal (MPa). In one or more implementations, the pressure that is provided on the one or more battery cells 304 by the foam 305 may be greater than 5 MPa. In one or more implementations, the foam 305 may be a non-conducting foam.

In order, for example, to manufacture the battery 300 of FIG. 3, one or more SSB pouch cells (e.g., battery cells 304 implemented as solid-state pouch cells) may be encased in the casing 302, and an expanding foam epoxy (e.g., foam 305 prior to expansion) may be injected in to the casing 302. The initial volume or amount of the foam 305 that is injected into the casing 302 may be sized to result in a final expanded volume that is larger than the remaining (e.g., free) volume left in the casing 302 (e.g., by a predetermined amount). In this way, the foam 305 can be injected such that an increase of pressure inside the casing 302 results from the expansion of the foam, providing the desired stack pressure for the battery cells 304. Once the foam 305 fills the remaining portion of the internal volume 303 and expands to provide the desired pressure on the battery cells 304, the foam 305 may set. The foam 305 may be provided in a closed cell implementation, in which the closed cell nature (e.g., the average or median cell size) of the foam can be tuned to provide a desired predetermined compliance to volume expansion. For example, once the foam 305 has set, an expansion of one or more of the battery cells 304 may press into the compliant set foam (e.g., which may give way to the expanding battery cell 304 without substantially changing the pressure on the battery cells 304 within the internal volume 303).

As shown in FIG. 3, each battery cell 304 may include one or more tabs that extend through the casing 302 (e.g., through a respective opening in the casing 302) to provide electrical contacts for the battery cells 304, externally to the casing 302 that is pressurized by the foam 305 As shown, the battery cells 304 may each include a first tab 306 (e.g., a positive polarity tab in the example of FIG. 3, which may correspond to the first terminal 235 of FIG. 2C) and a second tab 308 (e.g., a negative polarity tab, which may correspond to the second terminal 240 of FIG. 2C). As shown, the first tabs 306 may extend through a first surface 321 (e.g., a top surface) of the casing 302 and the second tabs 308 may extend through a second surface 323 (e.g., a bottom surface) of the casing 302 that is opposite to the first surface. In one or more implementations, the foam 305 may be a non-conducting foam that insulates spaces between portions of the first tabs 306 and/or the second tabs 308 that are disposed within the internal volume 303 of the casing 302.

FIG. 4 illustrates a cross-sectional end view of the battery 300 of FIG. 3 in an exemplary implementation in which a single row of battery cells 304 are disposed (e.g., end-to-end) in the internal volume 303. In the example of FIG. 4, the foam 305 may contact and provide a pressure on both on a first side 400 and a second side 402, opposite to the first side 400, of each battery cell 304. However, the example of FIG. 4 is merely illustrative. In other implementations, the battery 300 may include more than one row of battery cells 304.

For example, FIG. 5 illustrates a cross-sectional end view of the battery 300 of FIG. 3 in an implementation in which two rows of battery cells 304 are included in the casing 302 of the battery 300. In this example, the battery 300 may include one or more pairs 500 of battery cells 304 mounted within the internal volume 303 of the casing 302. As shown in the example of FIG. 5, each of the pairs 500 of battery cells 304 may include a first battery cell 304 mounted in a first polarity orientation (e.g., with a first tab, such as positive polarity tab extending through a first surface 321 such as a top surface of the casing, and a second tab 308, such as a negative polarity tab extending through a second surface 323 such as a bottom surface of the casing), and a second battery cell 304 mounted in a second polarity orientation opposite the first polarity orientation (e.g., with a first tab, such as positive polarity tab extending through a second surface 323 such as a bottom surface of the casing, and a second tab 308, such as a negative polarity tab extending through a first surface 321 such as a top surface of the casing). In this example, one side of each of the battery cells 304 of a pair 500 may be in contact with a corresponding side of the other battery cell 304 of that pair 500, and the foam 305 may bear against the opposing outer surfaces (e.g., and some or all of the edges) of the battery cells 304. In this arrangement, the foam 305 may press the battery cells 304 of the pairs 500 against each other with the desired stack pressure. In the example of FIG. 5, multiple pairs 500 may be disposed in a row of pairs 500 that are disposed end-to-end with each other within the casing 302. In this way, multiple rows of battery cells 304 (e.g., with alternating polarities) may be provided within the casing 302 of a battery 300. In the example of FIG. 5, two rows of battery cells 304 are provided in the casing 302. However, this is also merely illustrative. In other implementations, three rows, four rows, or more than four rows of battery cells 304 may be provided (e.g., in an end-to-end arrangement or in a side-to-side arrangement) and/or any number of battery cells 304 may be disposed within the casing 302 in in any other (e.g., non-rowed arrangement).

In the example of FIG. 5, the battery cells 304 of the pairs 500 are in contact with each other. However, in one or more other implementations, one or more other structures such as a temperature control element may be disposed between the first battery cell and the second battery cell of each of the pairs 500 of battery cells 304. For example, FIG. 6 illustrates a cross-sectional end view of the battery 300 in an implementation in which a temperature control element 600 is disposed between the battery cells 304 of the pairs 500. For example, the temperature control element 600 may include a vessel (e.g., a bladder, which may be formed from a rubber or rubber-like material, or any other compliant material that can conduct heat therethrough and that is robust to the stack pressure within the casing 302) through which a temperature control fluid (e.g., a cooling fluid or a warming fluid) may be passed or pumped, to cool or warm the battery cells 304. As another example, the temperature control element 600 may be a solid thermally conductive structure, such as a plate that conducts heat or cold to the battery cells 304 from a thermal source (e.g., a cold source or a heat source) external to the casing 302.

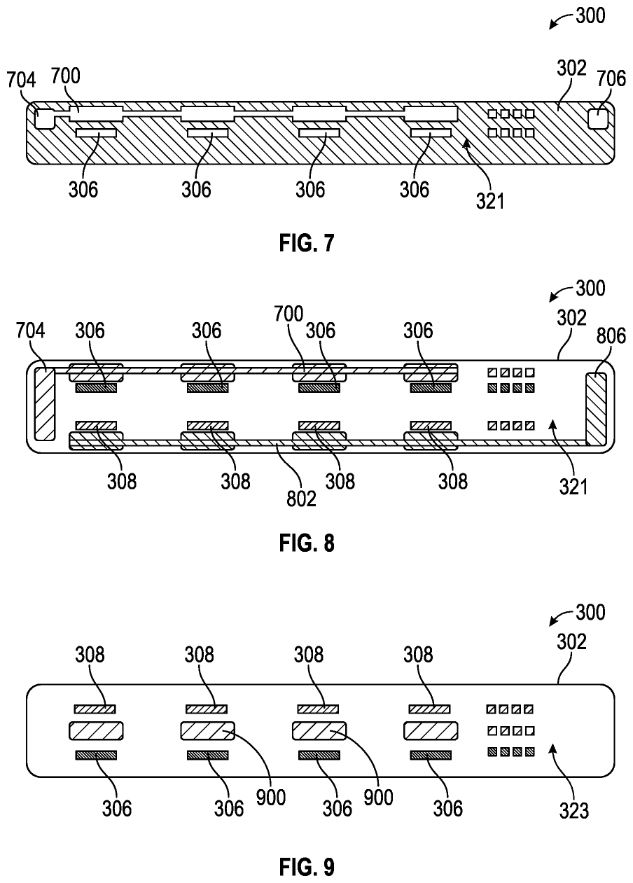

FIG. 7 illustrates a top view of the battery 300 in an implementation in which a single row of battery cells 304 are disposed within the casing 302 (e.g., as in the example of FIG. 4). As shown in FIG. 7, the casing 302 may include an interconnect busway 700 (e.g., a current collector) on an outer surface (e.g., the first surface 321, such as a top surface) of the casing 302. FIG. 7 also shows how each of the one or more battery cells may include a tab 306 that extends through the casing 302. In the examples of FIGS. 3-7, the tabs 306 and the tabs 308 are shown extending perpendicularly through corresponding openings in the casing 302. In one or more implementations, each of the tabs 306 may then be bent or folded over to into contact with a corresponding portion of the interconnect busway. In this way, the interconnect busway 700 may form a current collector that can be incorporated into the casing 302 of the battery 300, making the group of battery cells 304 inside the casing 302 into a unit corresponding to the battery 300.

As discussed herein, several of these resulting units (e.g., battery units such as batteries 300) can be connected to each other to build up series and/or parallel cells counts for the battery pack 110. For example, as shown in FIG. 7, the battery 300 may include an electrical contact 704 on the first surface 321 of the casing 302. The electrical contact 704 may be electrically coupled to the interconnect busway 700, and can be coupled, in series or in parallel, with another battery 300 in a battery pack 110, to couple the battery cells 304 within the casing 302 to the other battery 300. As shown, the battery 300 may include an electrical contact 706 on the first surface 321. In one or more implementations, the electrical contact 706 may be electrically coupled to yet another battery (e.g., to an electrical contact 704 on yet another battery 300).

In the example of FIG. 7, the interconnect busway 700 on the outer surface (e.g., first surface 321) of the casing 302 may form a positive parallel interconnect busway on the outer surface of the casing 302. In the example of FIG. 7, a negative parallel interconnect busway (not visible in the top view of FIG. 7) may be formed on an opposing surface (e.g., the second surface 323) of the casing and may be coupled to each of the tabs 308 on that side of the casing 302. In this example, a positive parallel interconnect busway is formed on one side of the casing 302 and a negative parallel interconnect busway is formed on an opposing side of the casing 302. However, as demonstrated by, for example, FIGS. 5 and 6, this example is merely illustrative.

For example, in one or more other implementations, a positive interconnect busway and a negative interconnect busway may be formed on the same surface of the casing 302. For example, as shown in FIG. 8, the casing 302 may include the interconnect busway 700 (e.g., a positive parallel interconnect busway) on the first surface 321 and coupled to a first battery cell (e.g., to a tab 306, such as a positive polarity tab) of each of one or more pairs 500 (see, e.g., FIGS. 5 and 6) of battery cells 304, and may also include an interconnect busway 802 (e.g., a negative parallel interconnect busway) on the (same) outer surface (e.g., the first surface 321) of the casing 302. For example, the interconnect busway 802 may be coupled to a second battery cell (e.g., to a tab 308, such as a negative polarity tab) of each of the one or more pairs 500 of battery cells. For example, in the example of FIG. 8, the tabs 306 may be folded over or bent into contact with (e.g., or otherwise electrically coupled to) corresponding portions of the interconnect busway 700, and the tabs 308 may be folded over or bent into contact with (e.g., or otherwise electrically coupled to) corresponding portions of the interconnect busway 802. As shown in FIG. 8, the battery 300 may also include an electrical contact 806 on the first surface 321 and coupled to the interconnect busway 802. In this arrangement, the electrical contact 704 may form a positive terminal for the battery 300 and the electrical contact 806 may form a negative terminal for the battery 300.

In the arrangement of FIG. 8, the tabs 306 and the tabs 308 on the opposite side of the pair 500 of the battery cells 304 may be coupled together. For example, FIG. 9 illustrates a bottom view of the battery 300 in the arrangement of FIG. 8. As shown in FIG. 9, the tabs 306 and the tabs 308 on the opposing sides of may extend through the second surface 323 of the casing 302. These tabs 306 and tabs 308 that extend through the second surface 323 may then be folded over or bent into contact with each other, coupling the positive terminal of one of the battery cells of a pair to the negative terminal of the other battery cell of the pair. In this way, a first battery cell of each of one or more pairs 500 (see, e.g., FIGS. 5 and 6) of battery cells may include a tab 306 that is coupled to a tab 308 of the second battery cell of that pair 500 of battery cells at a location adjacent another outer surface (e.g., the second surface 323) of the casing 302 that is opposite to the outer surface (e.g., the first surface 321) of the casing 302. In various implementations, the tabs 306 and tabs 308 that extend through the second surface 323 may be folded over or bent into contact direct with each other or into contact with a contact pad 900 by which the tabs 306 and the tabs 308 are electrically coupled together.

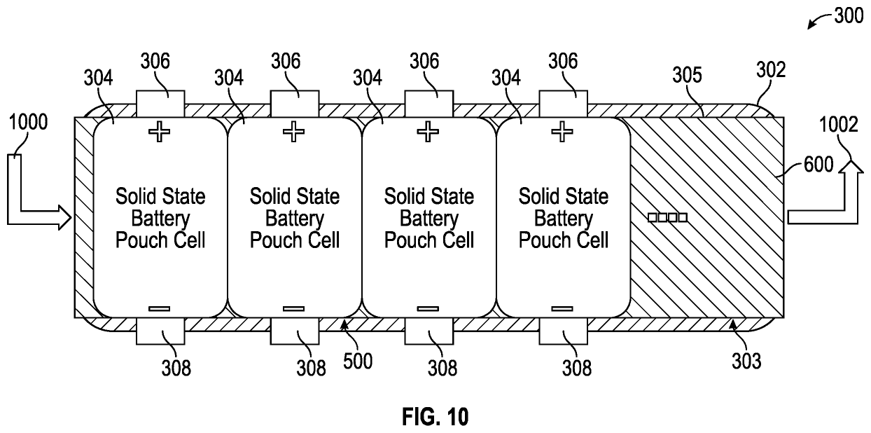

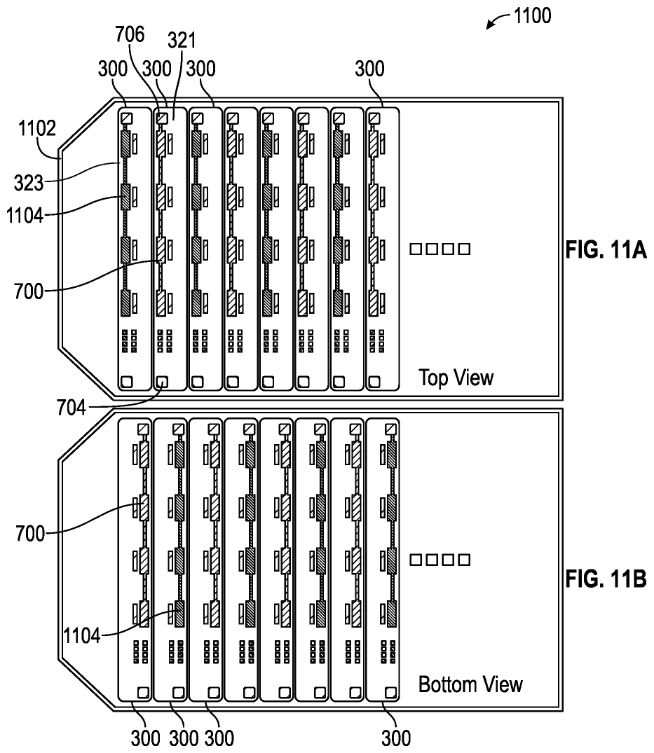

FIG. 10 illustrates a cross-sectional side view of the battery 300 in the implementation of FIG. 6. As shown in FIG. 10, the temperature control element 600 that is disposed between the battery cells 304 of the pairs 500 of battery cells 304 may be coupled to a temperature control input 1000 and a temperature control output 1002. For example, the temperature control input 1000 may be a fluid input port that is fluidly coupled to an interior cavity within the temperature control element 600. The temperature control output 1002 may be a fluid output port that is also fluidly coupled to the interior cavity within the temperature control element 600. In this way, a temperature control fluid, such as a cooling fluid or a warming fluid, may be passed through the battery 300 (e.g., through the interior cavity within the temperature control element 600) to cool or warm the battery cells 304 as desired.

In the examples of FIGS. 3-10, the battery cells 304 each include a tab 306 on one side and a tab 308 on an opposing side, and the tabs 306 and the tabs 308 of the battery cells 304 extend through opposing surfaces of the casing 302 to contact a current collector such as the interconnect busways 700 and 802. However, these arrangements are merely illustrative. In other implementations, the battery cells 304 of the battery 300 having the casing 302 and the foam 305 that pressurizes the internal volume 303 may be provided with positive and negative terminals (e.g., tabs) on the same side (e.g., a top side or any other side) of the battery cells (e.g., as in the example of FIG. 2C), and/or the interconnect busways may be provided on any other surface of the casing 302 or within the material that forms casing 302 (e.g., with a contact that extends externally of the casing 302) or within the internal volume 303 of the casing 302.

In one or more implementations, one or more of the battery 300 (having the casing 302 that defines the internal volume 303, one or more battery cells 304 disposed within the casing 302 and occupying a portion of the internal volume 303 of the casing 302, and the foam 305 that substantially fills a remaining portion of the internal volume 303 of the casing 302 and applies a pressure on the one or more battery cells 304) may be disposed (e.g., installed) in a battery pack, such as the battery pack 110 of FIGS. 1A-1C and 2A. For example, FIG. 11A illustrates a top view of an example in which multiple batteries 300 (e.g., battery units each having a casing 302, one or more battery cells 304, and a foam 305 as described herein) are disposed in a battery pack 1100 (e.g., an implementation of the battery pack 110) in a blade-style arrangement.

In the example of FIG. 11A, the battery pack 110 includes a pack frame 1102, and multiple batteries 300 disposed in the pack frame 1102. In this example, the batteries 300 are implemented as shown in FIG. 7, in which a positive polarity interconnect busway is disposed on a first surface 321 (e.g., a top surface) of the casing 302 and a negative polarity interconnect busway is disposed on a second surface 323 (e.g., a bottom surface) of the casing 302. As shown in the example of FIG. 11A, the batteries 300 may be installed in an alternating polarity arrangement in which batteries 300 with the positive polarity interconnect busways 700 (e.g., on the first surface 321) facing the top of the battery pack 1100 are alternatingly installed with batteries 300 with negative polarity interconnect busways 1104 facing the top of the battery pack 1100. FIG. 11B shows a bottom view of the battery pack 1100 of FIG. 11A. In FIG. 11B, the opposing (e.g., bottom) sides of the batteries 300 of FIG. 11A can be seen.

As illustrated by FIGS. 11A and 11B, in one or more implementations, the battery pack 1100 may include at least a first battery 300 in the pack frame 1102, the first battery including the casing 302, the one or more battery cells 304, and the foam 305, the first battery having a first polarity orientation; and a second battery 300 in the pack frame 1102 and having a second polarity orientation substantially opposite the first polarity orientation.

In one or more implementations, the batteries 300 in the pack frame 1102 may have the same properties (e.g., the same size, length, width, height, number of battery cells within the casing, stack pressure within the casing, cooling structures and/or elements, etc.) as each other. However, in the (e.g., blade-style) arrangement of FIGS. 11A and 11B, the batteries 300 within the pack frame 1102 may have varying properties (e.g., varying size, length, width, height, number of battery cells within the casing, stack pressure within the casing, cooling structures and/or elements, etc.) relative to the corresponding properties of other batteries 300 within the pack frame 1102. For example, in one or more implementations, the battery pack 1100 may include a first battery 300 having the casing 302, the one or more battery cells 304, and the foam 305, in which the foam 305 applies a first pressure on the one or more battery cells of the first battery; and a second battery 300 in which a second foam applies a second pressure, different from the first pressure, on one or more battery cells 304 of the second battery 300.

In the example of FIGS. 11A and 11B, the batteries 300 extend from one sidewall of the pack frame 1102 to an opposing sidewall of the pack frame 1102, and are mounted in a blade-style arrangement. In this arrangement, the batteries 300 may be replaceable and may be individually added or removed from the pack frame 1102 as desired. However, the arrangement shown in FIGS. 11A and 11B is merely illustrative and other arrangements of batteries 300 (having the battery cells 304 and the foam 305 that applies a pressure to the battery cells 304) are contemplated.

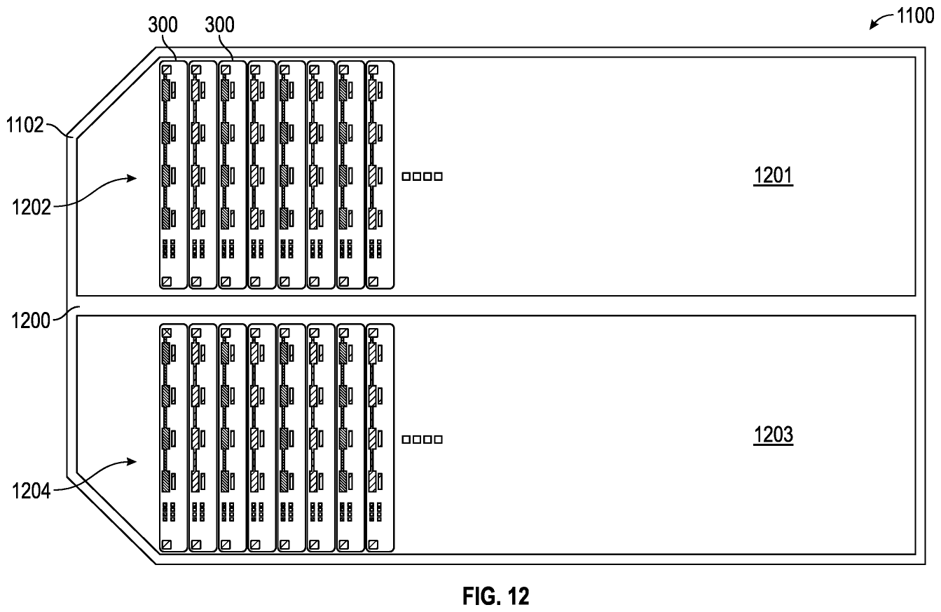

As one other example, FIG. 12 illustrates a top view of the battery pack 1100 in another implementation in which the pack frame 1102 includes a longitudinal support structure 1200 separating a first row 1202 of batteries 300 from a second row 1204 of batteries 300 within the pack frame 1102. In this example, the first row 1202 of batteries 300 is disposed in a first cavity 1201 on a first side of the longitudinal support structure 1200, and the second row 1204 of the batteries 300 is disposed in a second cavity 1203 on an opposing second side of the longitudinal support structure 1200. In the example of FIG. 12, any or all of the batteries 300 (e.g., including the battery units in the first row of battery units and/or the battery units in the second row of battery units) may include a casing 302, one or more battery cells 304, and the foam 305 that provides a pressure thereon, as described herein (e.g., as described herein in connection with FIG. 7).

In the examples of FIGS. 11A, 11B, and 12, the batteries 300 include a positive polarity interconnect busway on a first surface of the casing 302 and a negative polarity interconnect busway on an opposing second surface of the casing 302. However, the battery pack 1100 may be provided with one or more batteries or battery units having a different arrangement of interconnect circuitry in various other implementations.

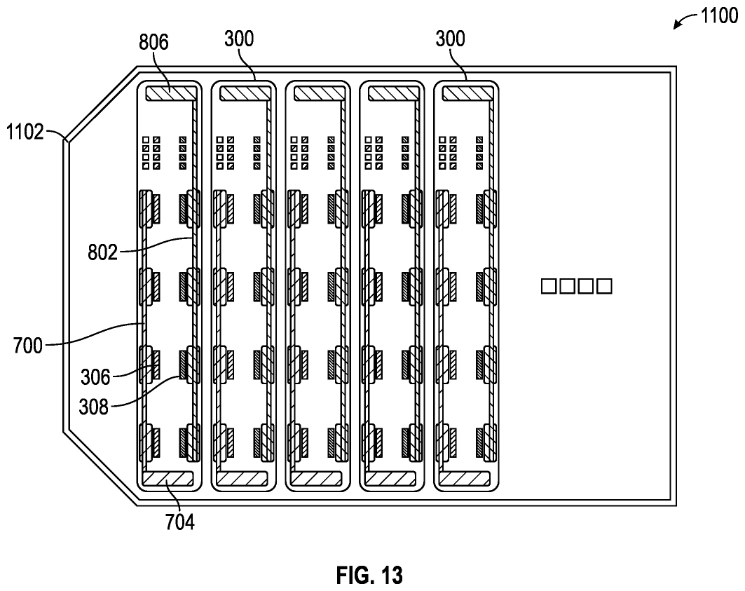

For example, FIG. 13 illustrates a top view of an example in which multiple batteries 300 having the arrangement of FIGS. 8 and 9 are disposed in a battery pack 1100 (e.g., an implementation of the battery pack 110) in a blade-style arrangement. In the example of FIG. 13, the battery pack 110 includes the pack frame 1102, and multiple batteries 300 disposed in the pack frame 1102. In this example, the batteries 300 are implemented as shown in FIGS. 8 and 9, in which a positive polarity interconnect busway 700 and a negative polarity interconnect busway 802 are both disposed on a first surface 321 (e.g., a top surface) of the casing 302.

In one or more implementations, the battery pack 1100 of FIG. 13 may include multiple batteries 300 in the pack frame 1102 that have the same properties (e.g., the same size, length, width, height, number of battery cells within the casing, stack pressure within the casing, cooling structures and/or elements, etc.) as each other. However, in the (e.g., blade-style) arrangement of FIGS. 13, the batteries 300 within the pack frame 1102 may have varying properties (e.g., varying size, length, width, height, number of battery cells within the casing, stack pressure within the casing, cooling structures and/or elements, etc.) relative to the corresponding properties of other batteries 300 within the pack frame 1102. For example, in one or more implementations, the battery pack 1100 of FIG. 13 may include a first battery 300 having the casing 302, the one or more battery cells 304, and the foam 305, in which the foam 305 applies a first pressure on the one or more battery cells of the first battery 300; and a second battery 300 in which a second foam applies a second pressure, different from the first pressure, on one or more battery cells 304 of the second battery 300.

In the example of FIG. 13, the batteries 300 extend from one sidewall of the pack frame 1102 to an opposing sidewall of the pack frame 1102, and are mounted in a blade-style arrangement. In this arrangement, the batteries 300 may be replaceable and may be individually added or removed from the pack frame 1102 as desired. However, the arrangement shown in FIG. 13 is merely illustrative and other arrangements of batteries 300 having the battery cells 304 and the foam 305 that applies a pressure to the battery cells 304 are contemplated.

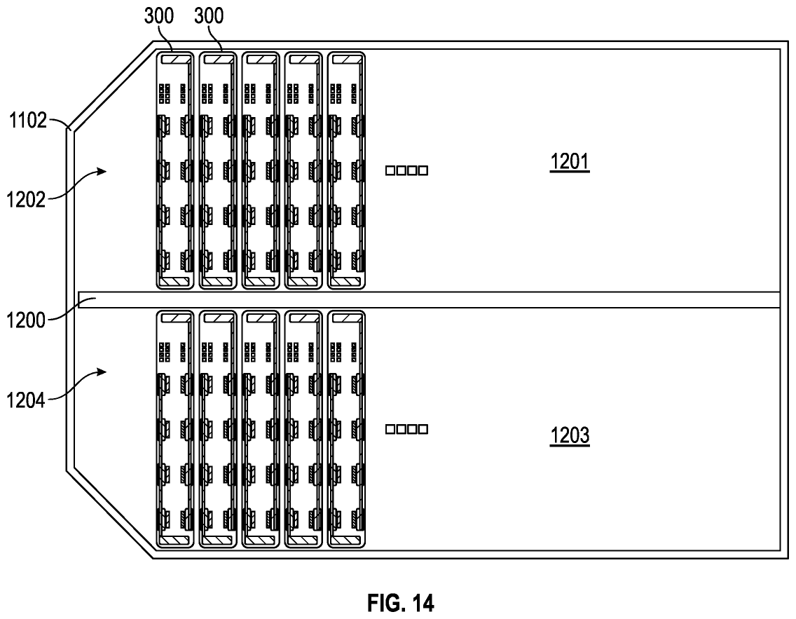

As one other example, FIG. 14 illustrates a top view of the battery pack 1100 in another implementation in which the pack frame 1102 includes a longitudinal support structure 1200 separating a first row 1202 of batteries 300 of FIGS. 8 and 9 from a second row 1204 of batteries 300 of FIGS. 8 and 9 within the pack frame 1102. In this example, the first row 1202 of batteries 300 is disposed in a first cavity 1201 on a first side of the longitudinal support structure 1200, and the second row 1204 of the batteries 300 is disposed in a second cavity 1203 on an opposing second side of the longitudinal support structure 1200. In the example of FIG. 14 any or all of the batteries 300 (e.g., including the batteries in the first row of battery units and/or the batteries in the second row of battery units) may include a casing 302, one or more battery cells 304, and the foam 305 that provides a pressure thereon, as described herein (e.g., as described herein in connection with FIGS. 8 and 9). In the examples of FIGS. 11A-14, batteries having a casing 302 are disposed in a pack frame 1102. However, it is also appreciated that, in one or more implementations, the battery cells 304 (e.g., solid-state pouch cells) may be mounted directly within the pack frame 1102 (e.g., without a casing 302), and the foam 305 may be injected into a remaining volume within the pack frame to substantially fill and pressurize (e.g., with a predetermined stack pressure as described herein) the interior volume of pack frame having the battery cells 304. In one or more implementations, the pack frame 1102 may form a casing 302 for one or more battery cells 304 and a foam 305 that substantially fills the pack frame 1102 and provides a desired stack pressure on the one or more battery cells 304 in the pack frame 1102.

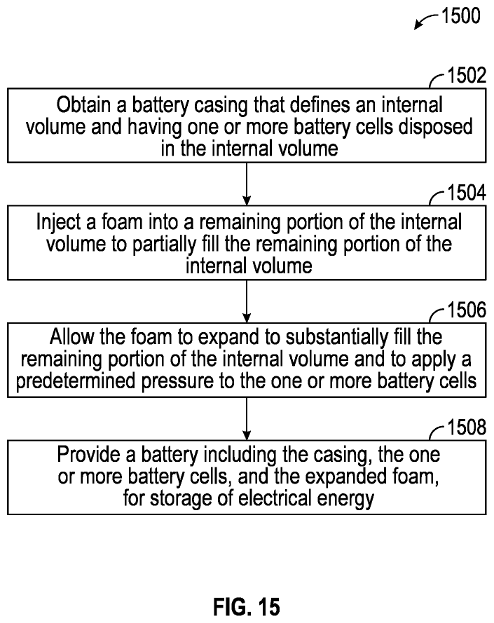

FIG. 15 illustrates a flow diagram of an example process 1500 that may be performed for manufacturing a battery, a battery unit, or a battery pack, in accordance with implementations of the subject technology. For explanatory purposes, the process 1500 is primarily described herein with reference to the battery 300 of FIGS. 1A-14. However, the process 1500 is not limited to the battery 300 of FIGS. 1A-14, and one or more blocks (or operations) of the process 1500 may be performed by one or more other structural components of other suitable moveable apparatuses, devices, or systems. Further for explanatory purposes, some of the blocks of the process 1500 are described herein as occurring in serial, or linearly. However, multiple blocks of the process 1500 may occur in parallel. In addition, the blocks of the process 1500 need not be performed in the order shown and/or one or more blocks of the process 1500 need not be performed and/or can be replaced by other operations.

As illustrated in FIG. 15, at block 1502, a battery casing (e.g., casing 302 or pack frame 1102) may be obtained that defines an internal volume (e.g., internal volume 303 or an internal volume of the pack frame 1102) and having one or more battery cells (e.g., battery cells 304, such as solid-state pouch cells) disposed in the internal volume. Obtaining the battery casing with the battery cells may include obtaining the casing, obtaining the battery cells, installing the battery cells in the casing, and closing the casing to form the internal volume that is partially occupied by the battery cells. Obtaining the battery casing with the battery cells may include obtaining the casing with the battery cells pre-installed within the casing.

At block 1504, a foam (e.g., foam 305 shown herein, prior to expansion) may be injected or otherwise introduced into a remaining portion of the internal volume to partially fill the remaining portion of the internal volume. In one or more implementations, the foam may be an expanding foam epoxy formed by mixing multiple parts (e.g., a resin and a hardener). In one or more implementations, the process 1500 may include mixing the parts of the expanding foam epoxy with a mixing ratio configured to result in a predetermined expansion ratio and/or a predetermined cell size of the foam. In one or more implementations, the process may include modifying a temperature of the foam and/or the ambient environment in which the foam is being injected, to control the expansion ratio, the cell size, and/or the expansion rate of the expanding foam. Injecting the foam into the remaining portion of the internal volume may include injecting an initial volume of the foam, the initial volume predetermined to expand within the internal volume to substantially fill and pressurize the internal volume. In one or more implementations, the foam may be formed from a non-conducting material such as a thermosetting polymer.

At block 1506, the foam may be allowed to expand to substantially fill the remaining portion of the internal volume and to apply a predetermined pressure to the one or more battery cells. For example, the predetermined pressure on the one or more battery cells may be greater than one MPa. As an example, the predetermined pressure on the one or more battery cells may be greater than five MPa. In one or more implementations, the foam may be allowed to expand to a density of greater than 0.1 grams per cubic centimeter (g/cc), greater than 0.2 g/cc, greater than 0.4 g/cc, greater than 0.5 g/cc, or greater than 1 g/cc. In one or more implementations, the foam 305 may be a closed cell foam.

At block 1508, a battery (e.g., battery 300, also referred to herein as a battery unit) including the battery casing, the one or more battery cells, and the expanded foam may be provided for storage of electrical energy. For example, in one or more implementations, the process 1500 may also include installing the battery in a vehicle (e.g., the vehicle 100 as described herein). In one or more implementations, the battery may be installed in a battery pack (e.g., battery pack 1100, which may be an implementation of the battery pack 110). The battery pack may be installed in the vehicle, or may be installed elsewhere (e.g., in a building 180) for storage of electrical energy. In one or more implementations, the battery may be combined with one or more other batteries to form a battery module. In one or more other implementations, the battery may form a battery module.

Aspects of the subject technology can help improve the efficiency and/or reduce the weight of electrical power supplies, such as batteries and/or battery packs. This can help facilitate the functioning of and/or extend the range of electric vehicles, which can positively impact the climate and mitigate climate change by reducing greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A battery, comprising:
a casing that defines an internal volume,
wherein the casing is configured to enclose one or more battery cells within a portion of the internal volume of the casing, and
wherein a foam that substantially fills a remaining portion of the internal volume of the casing is configured to apply a pressure on the one or more battery cells.

2. The battery of claim 1, further comprising the one or more battery cells disposed within the portion of the internal volume of the casing, wherein the one or more battery cells are solid state pouch cells each having a flexible pouch housing that is in contact with and receives the pressure from the foam.

3. The battery of claim 1, wherein the foam has a density greater than 0.4 grams per cubic centimeter.

4. The battery of claim 1, wherein the foam comprises a closed cell foam that applies the pressure on the one or more battery cells and that is compliant to allow an expansion of one or more of the one or more battery cells while substantially maintaining the pressure on the one or more of the one or more battery cells.

5. The battery of claim 1, wherein the pressure on the one or more battery cells is greater than one MPa.

6. The battery of claim 5, wherein the pressure on the one or more battery cells is greater than five MPa.

7. The battery of claim 1, further comprising an interconnect busway on an outer surface of the casing, wherein each of the one or more battery cells comprises a tab that extends through the casing and contacts a corresponding portion of the interconnect busway.

8. The battery of claim 7, wherein the one or more battery cells comprise one or more pairs of battery cells mounted within the internal volume of the casing, wherein each of the one or more pairs of battery cells comprises a first battery cell mounted in a first polarity orientation, and a second battery cell mounted in a second polarity orientation opposite the first polarity orientation.

9. The battery of claim 8, further comprising a temperature control element disposed between the first battery cell and the second battery cell of each of the one or more pairs of battery cells.

10. The battery of claim 8 wherein the interconnect busway on the outer surface of the casing comprises a positive parallel interconnect busway on the outer surface of the casing and coupled to the first battery cell of each of the one or more pairs of battery cells, and wherein the battery further comprises a negative parallel interconnect busway on the outer surface of the casing and coupled to the second battery cell of each of the one or more pairs of battery cells.

11. The battery of claim 10, wherein the first battery cell of each of the one or more pairs of battery cells comprises a tab that is coupled to a tab of the second battery cell of that pair of battery cells at a location adjacent another outer surface of the casing that is opposite to the outer surface of the casing.

12. A battery pack, comprising:
a casing that defines an internal volume,
wherein the casing is configured to enclose one or more battery cells within a portion of the internal volume of the casing, and
wherein a foam that substantially fills a remaining portion of the internal volume of the casing and is configured to apply a pressure on the one or more battery cells.

13. The battery pack of claim 12, further comprising:
a pack frame;
a first battery unit in the pack frame, the first battery unit including the casing, the one or more battery cells, and the foam, the first battery unit having a first polarity orientation; and
a second battery unit in the pack frame and having a second polarity orientation substantially opposite the first polarity orientation.

14. The battery pack of claim 12, further comprising the one or more battery cells disposed within the portion of the internal volume of the casing, wherein the foam comprises a closed cell foam and wherein the pressure on the one or more battery cells comprises a pressure of greater than 1 MPa.

15. The battery pack of claim 12, further comprising:
a pack frame;
a first battery unit having the casing, the one or more battery cells, and the foam, and in which the foam applies a first pressure on the one or more battery cells of the first battery unit; and
a second battery unit in which a second foam applies a second pressure, different from the first pressure, on one or more battery cells of the second battery unit.

16. The battery pack of claim 12, further comprising a pack frame with a longitudinal support structure separating a first row of battery units from a second row of battery units within the pack frame, wherein the first row of battery units comprises a first battery unit including the casing, the one or more battery cells, and the foam.

17. The battery pack of claim 12, wherein the battery pack is implemented in a vehicle.

18. A method, comprising:
obtaining a battery casing that defines an internal volume and having a plurality of battery cells disposed in the internal volume;
injecting a foam into a remaining portion of the internal volume to partially fill the remaining portion of the internal volume;
allowing the foam to expand to substantially fill the remaining portion of the internal volume and to apply a predetermined pressure to the plurality of battery cells; and
providing a battery comprising the casing, the plurality of battery cells, and the expanded foam, for storage of electrical energy.

19. The method of claim 18, wherein the predetermined pressure on the plurality of battery cells is greater than one MPa.

20. The method of claim 18, further comprising installing the battery in a vehicle.
